(19) United States
(12) Patent Application Publication
(10) Pub. No.: US 2007/0219739 A1
(43) Pub. Date: Sep. 20, 2007

(54) Mixer measurement system and method using a chaotic signal

(76) Inventors: Brian K. Spears, Dublin, CA (US); John Wood, Tempe, AZ (US); Nicholas B. Tufillaro, Corvallis, OR (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/376,505

(22) Filed: Mar. 15, 2006

(51) Int. Cl. G06F 19/00

(52) U.S. Cl. 702/85; 702/1; 702/107; 702/106; 702/108; 702/109

(57) ABSTRACT

A mixer measurement system and method use a chaotic signal to characterize a mixer under test. The mixer measurement system includes a chaotic reference source, an excitation source at an input end of the mixer under test and an inverse system at an output end of the mixer under test. The inverse system removes a chaotic component from a response signal from the stimulated mixer under test to produce a recovered signal having an included distortion that is characteristic of the mixer under test. The method of characterizing a mixer includes applying the chaotic stimulation to the mixer under test to obtain a response signal and employing the inverse system to remove the chaotic component from the response signal.

### CROSS-REFERENCE TO RELATED APPLICATIONS

N/A

### STATEMENT REGARDING FEDERALLY SPONSORED RESEARCH OR DEVELOPMENT

N/A

### BACKGROUND

A mixer is a three-port device that has a pair of input ports and an output port. Mixers are often used as signal multipliers. As a signal multiplier, the mixer may be used to produce an output or product signal by multiplying together a pair of input signals. A typical use of a mixer is for effecting frequency translations in upconversion and downconversion stages of transmitters and receivers. For example, a mixer may be used to multiply together a radio frequency (RF) signal applied to a first input port (e.g., RF port) and a local oscillator (LO) signal at a second input port (e.g., LO port) to generate an intermediate frequency (IF) signal at the output port (e.g., IF port). As such, analog mixers and their digital counterparts find use in a wide variety of radar, communication and signal processing systems and related applications.

While the function of a mixer is to multiply input signals to produce an output signal representing a product of the input signals, mixers are real devices that exhibit non-ideal, ‘nonlinear’ or spurious outputs in addition to the desired product of signals. As such, characterization of the non-ideal or ‘non-linear’ performance of a mixer is typically an important component in the manufacturing and testing of both mixers and the systems that employ mixers.

There are many possible metrics that can be and often are used to characterize mixer nonlinearities including, but not limited to, total harmonic distortion (THD), second order distortion, third order distortion, and multiple signal intermodulation distortion. In the time domain, an analogous metric to THD is root mean square (RMS) error between an actual output signal produced by a mixer and an ideal signal from an ideal model of the mixer. To characterize mixer nonlinearities, conventional mixer test systems typically apply one or more single-frequency sinusoidal signals to each of the mixer input ports and measure the output signal at the output port. The results of such a test exemplify the mixer performance at essentially a single frequency or set of single frequencies. As such, to characterize a mixer across an operational band of frequencies of interest, many ‘single-frequency’ tests, each at a different frequency across the operational band, are typically employed. Only after completing many single-frequency tests can a complete broadband characterization of the mixer be constructed or synthesized from the various individual tests.

### BRIEF SUMMARY

In some embodiments of the present invention, a mixer measurement system employing a chaotic signal is provided. The mixer measurement system comprises a chaotic reference source having an output that produces a chaotic reference signal on a first input of a mixer under test. The mixer measurement system further comprises an excitation source having an output that produces a stimulus signal on a second input of the mixer under test, the mixer under test generating a response signal that includes a distortion introduced by the mixer under test. The mixer measurement system further comprises an inverse system that removes a chaotic component from the response signal to measure a recovered signal that includes the distortion.

In other embodiments of the present invention, a method of characterizing a mixer using a chaotic signal is provided. The method of characterizing comprises applying a stimulus signal and a chaotic reference signal to inputs of a mixer under test to produce a response signal from an output of the mixer under test. The method of characterizing further comprises employing an inverse system on the response signal to remove a chaotic component from the response signal such that a recovered signal having an included distortion that is characteristic of the mixer under test is produced.

Certain embodiments of the present invention have other features that are one or both of in addition to and in lieu of the features described above. These and other features of the invention are detailed below with reference to the following drawings.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates a block diagram of a mixer measurement system according to an embodiment of the present invention.

FIG. 2 illustrates a block diagram of a chaotic excitation source according to an embodiment of the present invention.

FIG. 3 illustrates a block diagram of a mixer measurement system according to another embodiment of the present invention.

FIG. 4 illustrates a flow chart of a method of characterizing a mixer using chaotic stimulation according to an embodiment of the present invention.

FIG. 5 illustrates a flow chart of a method of characterizing a mixer using chaotic stimulation according to another embodiment of the present invention.

FIG. 6 illustrates a block diagram of a mixer measurement system according to another embodiment of the present invention.

FIG. 7 illustrates a block diagram of a mixer measurement system according to another embodiment of the present invention.

### DETAILED DESCRIPTION

The embodiments of the present invention facilitate characterizing a broadband performance of a mixer. In some embodiments, a nonlinear performance is characterized. The characterization is performed using a multi-frequency or broadband stimulation signal having a rich or extended spectral structure. As a result, some embodiments of the present invention may provide a broadband characterization of the mixer with a single test. Various embodiments of the present invention are applicable to characterizing a wide variety of analog mixers including, but not limited to, intermediate frequency (IF) mixers, radio frequency (RF) mixers, microwave mixers, and millimeter band mixers. Other embodiments characterize digital mixers and related multiplier circuits. Examples of broadband nonlinear characterizations that may be realized with various embodiments of the present invention include, but are not limited to, total harmonic distortion (THD), second order distortion characterization, and third order distortion and intermodulation characterization.

According to some embodiments of the invention, a chaotic signal is employed as a reference signal in conjunction with a chaotic excitation source to essentially provide a baseband-to-baseband test of a mixer under test (MUT). In some embodiments, a chaotic excitation signal S(t) is produced by the chaotic excitation source using an arbitrary input signal u(t) and a chaotic reference signal C(t) from a chaotic reference source. The chaotic excitation signal S(t) is applied to a first input of the MUT. The chaotic reference signal C(t) is applied to a second input port of the MUT. The MUT produces an output or response signal R(t). The response signal R(t) is applied to an inverse system that produces a recovered signal ũ(t) that essentially represents the input signal u(t) plus distortions introduced by the MUT. In some embodiments, the recovered signal ũ(t) is analyzed to quantify the distortions. For example, the recovered signal ũ(t) may be compared to the input signal u(t) using a multiple regression analysis to estimate one or more parameters associated with the distortions introduced by the MUT (e.g., THD, second order distortions, third order distortions, etc.)

As used herein, the term ‘chaotic’ used with a signal refers to a signal that exhibits chaotic motion or chaotic oscillation. For a signal to exhibit chaotic oscillation, a characteristic of the signal (e.g. one or both of magnitude and phase, as a function of time) generally follows or ‘traces out’ an essentially chaotic trajectory or orbit when plotted or viewed in a state space or as a phase diagram (i.e., the signal exhibits chaotic motion). Specifically, when plotted or represented in state space, a characteristic of the chaotic signal will exhibit or trace out a trajectory exemplified by a strange attractor as opposed to a so-called normal attractor. A chaotic signal may be an output of, or produced by, a chaotic system, for example. The chaotic system is defined as a system in which a characteristic or operational mode thereof is governed by, or is defined in terms of, chaos theory.

Chaos theory is a branch of both mathematics and physics that deals with certain nonlinear dynamical systems known to exhibit chaos. A principle characteristic of chaos is a high degree of sensitivity to initial conditions. In particular, a fundamental property of chaotic oscillation is an inherent, long-term unpredictability associated with small variations or perturbations in an initial condition of a deterministic system. For example, a deterministic system having an output which diverges rapidly (e.g., exponentially) in essentially differing directions in state space, as a result of small perturbations in the initial conditions of the system, exhibits chaos and is typically termed a ‘chaotic system’. For example, a Lorenz system associated with a so-called Lorenz attractor is a well-known chaotic system that may be employed to generate a chaotic signal. A Lorenz system, defined in terms of coupled differential equations, is described in more detail below. Chaos theory and examples of other chaotic systems and signals are familiar to one skilled in the art as exemplified by N. B. Tufillaro et al., An Experimental Approach to Nonlinear Dynamics and Chaos, Addison-Wesley, 1992, incorporated herein by reference.

Chaos and chaotic outputs may arise in certain types of solutions to a differential equation or a set of differential equations. In particular, when a solution has two orbits or trajectories in state space, such that the two orbits begin close together for close initial conditions and diverge essentially exponentially from one another as time progresses, the solution is typically considered to exhibit chaos, i.e., a chaotic solution.

A classical example of a chaotic system described by such a chaotic solution type is that of a differential equation describing an inverted pendulum started or released at an apex of the pendulum's motion. Small perturbations in an initial condition (e.g., initial or release location) of the inverted pendulum result in a motion of the pendulum away from the apex that is in either a clockwise or a counterclockwise direction about a point of rotation of the pendulum. When plotted in state space, these small perturbations in the initial condition of the pendulum produce two distinctly different and rapidly diverging orbits, one for the clockwise rotation and a second for the counterclockwise rotation.

Another example of a chaotic system is a dynamical system governed or described by the Lorenz system comprising a system of three coupled ordinary differential equations (ODEs) given by equation (1)
x′=σ(x−y)
y′=rx−y−xz
z′=xy−bz (1)
where variables x′, y′ and z′ are first derivatives with respect to time of variables x, y and z, respectively, and parameters σ, b and r are arbitrary predetermined constants, for example and not by way of limitation, parameter σ may equal 10, parameter b may equal 8/3, and parameter r may equal 28.

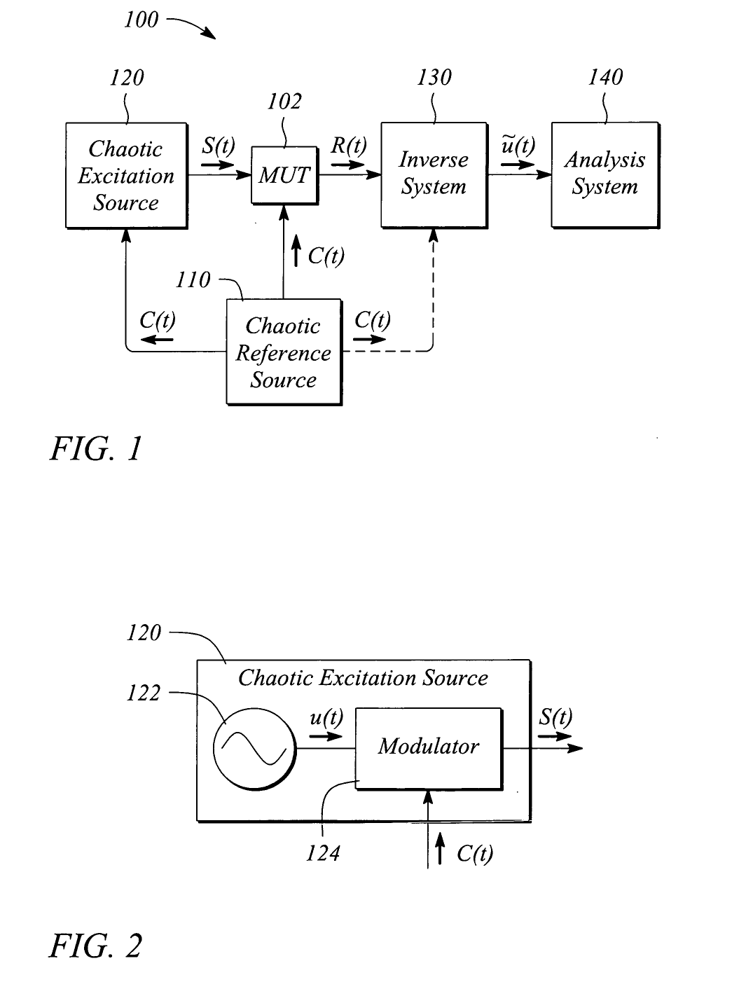

FIG. 1 illustrates a block diagram of a mixer measurement system 100 according to an embodiment of the present invention. The mixer measurement system 100 stimulates a mixer under test (MUT) 102 with a chaotic signal. A response of the stimulated MUT 102 is detected and measured by the mixer measurement system 100 to characterize the MUT 102. In particular, a chaotic signal component embedded in a stimulation signal applied to the MUT 102 is employed by the mixer measurement system 100 to perform a broadband characterization a nonlinear performance exhibited by the MUT 102. The nonlinear performance results in distortion of a response signal produced by the MUT 102 when stimulated by the mixer measurement system 100.

As illustrated in FIG. 1, the measurement system 100 comprises a chaotic reference source 110. The chaotic reference source 110 produces a chaotic reference signal C(t). Essentially any signal source capable of producing a chaotic signal C(t) may be employed as the chaotic reference source 110. For example, an arbitrary waveform generator appropriately programmed to generate the chaotic reference signal C(t) may be employed as the chaotic reference source 110. In another example, a computer simulation of a chaotic system (e.g., solution to a set of differential equations), an output of which is passed through a digital to analog converter (DAC), may be employed as the chaotic reference source 110. In yet another example, an oscillator modulated by a chaotic system may be employed as the chaotic reference source 110.

An output of the chaotic reference source 110 is connected to an input port of the MUT 102 such that the chaotic reference signal C(t) is applied to the MUT 102. In general, the chaotic reference source 110 may be connected to either one of the input ports of the MUT 102. For example, when the connection is to an local oscillator (LO) input port of the MUT 102, the chaotic reference signal C(t) acts as an LO signal. When the chaotic reference source 110 output is connected to an RF input port of the MUT 102, the chaotic reference signal C(t) acts as an RF signal, for example.

For discussion purposes and not by way of limitation, the MUT 102 will be described in terms of a downconverting RF MUT 102 having an LO input port, an RF input port and an IF output port unless otherwise noted. One skilled in the art may readily extend the discussion herein to operating other frequency bands (e.g., IF band, millimeter band) and to an upconverting MUT 102 without undue experimentation.

The mixer measurement system 100 further comprises a chaotic excitation source 120 that produces a chaotic stimulus signal S(t) at an output thereof. The chaotic stimulus signal S(t) is synchronized with the chaotic reference signal C(t). In particular, the chaotic excitation source 120 produces the chaotic stimulus signal S(t) comprising a component that is proportional to the chaotic reference signal C(t). As such, the chaotic stimulus signal S(t) and the chaotic reference signal C(t) are said to be ‘synchronized’ by virtue of the proportionality therebetween.

In some embodiments, the chaotic reference source 110 is connected to the chaotic excitation source 120 such that the chaotic excitation source 120 receives the chaotic reference signal C(t). Such a connection is illustrated in FIG. 1. The chaotic reference signal C(t) received by the chaotic excitation source 120 through the connection may be employed to facilitate the above-mentioned synchronization.

In some embodiments, the chaotic stimulus signal S(t) may comprise an arbitrary input signal u(t) that is modulated by the chaotic reference signal C(t). For example, the input signal u(t) may be a sinusoidal signal with a center frequency at or near a center of a frequency band of interest for the characterization. In some embodiments, the input signal u(t) is multiplied by the chaotic reference signal C(t) to achieve the modulation and produce the chaotic stimulus signal S(t).

The output of the chaotic excitation source 120 is connected to another input of the MUT 102 other than the MUT 102 input to which the output of the chaotic reference source 110 is attached. For example, when the chaotic reference source 110 is connected to the LO port of the MUT 102, the chaotic excitation source 120 is connected to the RF input port of the MUT 102. As such, the chaotic stimulus signal S(t) is applied as a second input signal to the MUT 102.

FIG. 2 illustrates a block diagram of a chaotic excitation source 120 according to an embodiment of the present invention. As illustrated in FIG. 2, the chaotic excitation source 120 comprises a signal source 122 and a modulator 124. The signal source 132 includes, but is not limited to, a continuous wave (CW) source, such as an oscillator, a digital to analog (DAC) converter driven by a computer having a computer program that implements a model of a signal, and an appropriately programmed arbitrary waveform generator, for example. In other embodiments, the signal source 122 is a digital signal source such as, but not limited to, a computer having a computer program or a dedicated circuit implementing a digital signal source (e.g., discrete logic circuit, ASIC, etc.). The signal source 122 produces the input signal u(t), which is applied to the modulator 124.

The modulator 124 receives the input signal u(t) from the signal source 122 and further receives the chaotic reference signal C(t) from the chaotic reference source 110. The modulator 124 imparts a modulation to the input signal u(t) that is proportional to the chaotic reference signal C(t). A modulated output signal produced by the modulator 124 is the chaotic stimulus signal S(t) of the chaotic excitation source 120 illustrated in FIGS. 1 and 2, depending on the embodiment.

In general, the modulator 124 may be essentially any analog modulator, digital modulator, or combination thereof that can modulate the signal from the signal source 122 according to the chaotic reference signal C(t). In some embodiments, the modulator 124 is a mixer 124. The mixer 124 is essentially a signal multiplier that multiplies together a pair of signals to produce a product thereof. The mixer 124 employs the chaotic reference signal C(t) as a chaotic carrier. The input signal u(t) from the signal source 132 is essentially ‘added’ by the action of the mixer 124 to the chaotic carrier as a sideband to produce the chaotic excitation signal S(t). In other embodiments, the modulator 124 is a digital modulator that receives a digital input or inputs and generates an analog output signal compatible with the MUT 102 input. In such embodiments, the modulator 124 may be a digital multiplier followed by a DAC, for example. Also, in such embodiments, the chaotic reference source 110 may provide a digital representation of the chaotic reference signal C(t) to the digital modulator 124.

For example, the modulator 124 may comprise an analog voltage multiplier such as, but not limited to, a microwave or millimeter wave mixer and an analog multiplier (i.e., either real or complex). In another example, the modulator 124 comprises a digital multiplier. In yet other exemplary embodiment, the modulator 124 is implemented as a computer program in either a general purpose computer or a specialized processor. Examples of a specialized processor include, but are not limited to, a discrete logic circuit, a signal processor and an application specific integrated circuit (ASIC).

In some embodiments (not illustrated), the chaotic excitation source 120 may further comprise an output (e.g., an output port) that is connected to an input (e.g., an input port) of the chaotic reference source 110. A signal produced by the chaotic excitation source 120 at the output may be the input signal u(t) from the signal source 122, for example. In such embodiments, the chaotic reference source 110 may employ the input signal u(t) in generating the chaotic reference signal C(t). For example, the chaotic reference source 110 may employ the input signal u(t), as described by the modulator equations (2) discussed below.

The MUT 102 produces a response signal R(t) from the applied chaotic reference signal C(t) and chaotic stimulus signal S(t) of the mixer measurement system 100. For an ideal mixer, the response signal R(t) is simply a product of the applied signals. However, the MUT 102 has nonlinearities that manifest as distortions. As such, the response signal R(t) is a distorted product of the applied chaotic reference signal C(t) and chaotic stimulus signal S(t).

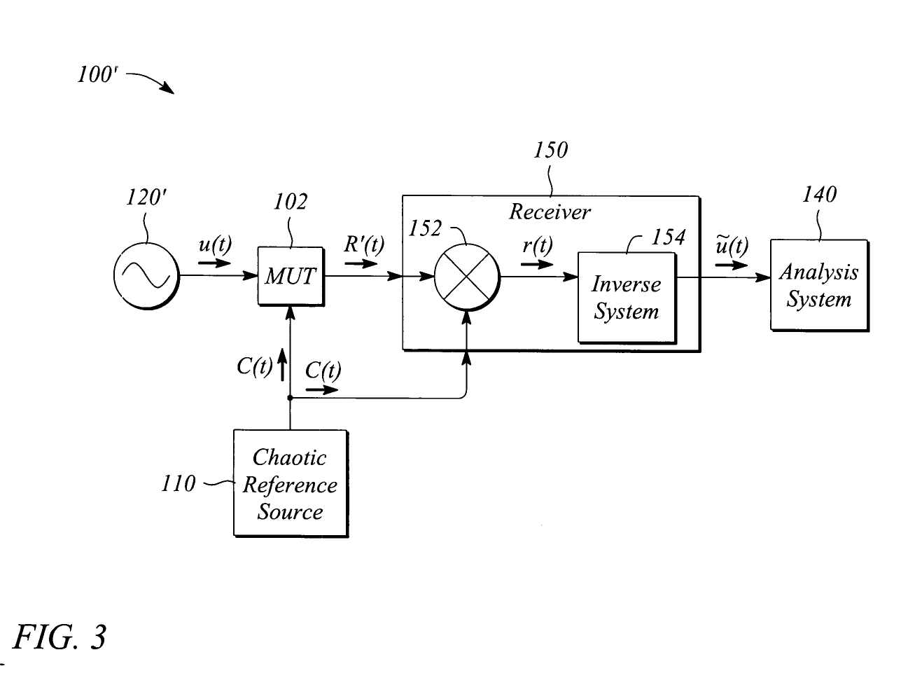

The mixer measurement system 100 further comprises an inverse system that acts as a receiver that receives the response signal R(t) and generates a recovered signal ũ(t). FIG. 1 illustrates an embodiment of the mixer measurement system 100 having an inverse system 130, wherein an output of the MUT 102 is connected to an input of the inverse system 130. FIG. 3 illustrates an embodiment of a mixer measurement system 100′ having an inverse system 154 included in a receiver 150. An output of the MUT 102 is connected to an input of the receiver 150 and indirectly connected to the inverse system 154. The embodiment of the mixer measurement system 100′ is described in more detail later. In both embodiments, the inverse system 130, 154 generates the above-mentioned recovered signal ũ(t).

As discussed above, the recovered signal ũ(t) essentially represents the input signal u(t) plus distortions introduced by the MUT 102. As used herein, the ‘inverse system’ is defined as any system that essentially implements a mathematical inverse of a chaotic modulation present in the response signal R(t). In other words, the inverse system essentially inverts non-transient behavior of a nonlinear dynamical system represented by the chaotic modulation. In particular, the inverse system may be implemented as, or described by, a set or system of inverse demodulator equations that essentially undo or implement an inverse of a set or system of modulator equations. Examples of using inverse functions in chaotic communications system is described by Abel et al., in “Chaos Communications—Principles, Schemes, and System Analysis,” Proc. IEEE, Vol. 90, No. 5, May 2002, pp. 691-710, incorporated herein by reference. In some embodiments of the inverse system, specific knowledge of how the chaotic modulation is created is employed in order to undo or remove it from the chaotic response signal R(t).

In some embodiments of the chaotic reference source that employ the inverse system, the chaotic reference signal C(t) may essentially transmit or carry an explicit copy of an input signal u(t). In addition, when a difference system is used to generate the chaotic reference signal C(t), the difference system may have a fixed point at an origin to assist in self-synchronization between a signal used to stimulate the MUT 102 and a response signal from the MUT 102. Further, in order to provide relatively robust synchronizations in view of small perturbations, the fixed point may be hyperbolic, in some embodiments. Moreover, in some embodiments, eigenvalues of the fixed point are essentially negative such that transients will decay relatively quickly. Such a chaotic reference signal C(t) may be readily implemented as a simple analog circuit, for example. Examples of circuits that may be employed to generate the chaotic reference signal C(t) for use with the inverse system is presented by J. C. Sprott, “Simple chaotic systems and circuits,” Am. J. Phys., Vol. 68, No. 8, August 2000, pp. 758-763, and by K. Kiers et al., “Precision measurement of a simple chaotic circuit,” Am. J. Phys., Vol. 72, No. 4, April 2004, pp. 503-509, both of which are incorporated by reference herein.

For example and not by way of limitation, a nonautonomous, three-dimensional oscillator system described in terms of a 3-dimensional state vector x=(x₁(t), x₂(t), x₃(t)) may be employed to generate a suitable chaotic reference signal C(t) by modulator equations (2) below. The modulator equations are given by
x′=Ax+bƒ(x,u)
y=c^{T}x+ƒ(x,u)
ƒ(x,u)=(x₁+DC)²·u(t) (2)
where the vector x′ is a first time derivative of the state vector x, the variable y is an output of the modulator equations (2), the matrix A is a constant matrix that defines a linear dynamic differential equation given by x′=Ax, the vector b is a 3-dimensional column vector of predetermined, arbitrarily chosen coefficients (e.g., b=[0,0,1]^{T}), the vector c^{T} is a transpose of another 3-dimensional vector of predetermined, arbitrarily chosen coefficients (e.g., c^{T}=[1,0,0]), and the term DC is a predetermined, arbitrarily chosen, constant offset. A first variable x₁(t) of the vector x is referred to as a modulator. The modulator x₁(t) may be passed through a band-limiting filter so that the variable has a well-defined center frequency. In some embodiments, the well-defined center frequency is much higher than a center frequency of the input signal u(t). In some embodiments, the modulator x₁(t) is essentially equivalent to the chaotic reference signal C(t). The function ƒ(·) may be essentially any function. Explicit reference to time t is suppressed in the modulator equations (2) for notational simplicity and not by way of limitation.

Inverse demodulator equations corresponding to the modulator equations (2) may be given by demodulator equations (3) as
z′=Az+b(y−c^{T}z)
ũ=ƒ⁻¹(z,y−c^{T}z) (3)
where the vector z′ is a first time derivative of the state vector z, and ƒ⁻¹(·) is an inverse of the function ƒ(·) with respect to the input signal u. In equations (3), the term ũ is essentially the input signal u(t) plus any signal characteristics or distortion products introduced by the action of the MUT 102. As such, ũ (i.e., ũ(t)) represents an output of the mixer measurement system 100 that may be analyzed for information (e.g., distortion) regarding performance of the MUT 102.

In some embodiments, the inverse function ƒ⁻¹(·) is essentially a function that produces a feedback (e.g., a simplest feedback) that will create chaotic motion for parameter regions that are experimentally realizable. For example, if the function ƒ(·) is a quadratic function, the inverse dynamical system and associated inverse function ƒ⁻¹(·) is readily determined using the quadratic formula and keeping track of which root of the quadratic is being employed. In general, the inverse function ƒ⁻¹(·) may be determined either analytically or numerically (e.g., using a root finding algorithm). For example, see M. Sain et al., “Invertibility of Linear Time-Invariant Dynamical Systems,” IEEE Trans. Automatic Control, Vol. 14, No. 2, April 1969, pp. 141-149, incorporated herein by reference.

A difference system applicable to the above-described modulator equations (2) and demodulator equations (3) is described by equations (4) as
d′=A√d−b(c^{T}·d)
d=x−z (4)
where the vector d′ is a state vector of the difference system. The difference system described by equations (4) essentially measures the difference between the input and output signals. Specifically, the difference system state vector d approaches zero as the systems represented by the modulator equations (2) and the demodulator equations (3), respectively, become synchronized.

In an example of employing equations (2)-(4), let the vector c=0, so that the scalar variable y=ƒ(x,u) and the inverse system simply comprises an inverse function ƒ¹(x,u) with respect to the input signal u(t). The exemplary chaotic stimulus signal S(t) created by the excitation source 120 and applied to an input of the MUT 102 may be given by a last equation of the modulator equations (2), namely S(t)=(x₁(t)+DC)·u(t). Similarly, the chaotic response signal R(t) equals (x₁(t)+DC)²·u(t). For the example, the inverse system may comprise an inverse of a quadratic function where ƒ(·) is a quadratic function and an inverse of a cubic function where ƒ(·) is a cubic function. In either case, the inverse function is generally known analytically.

In some embodiments of the inverse system 130 illustrated in FIG. 1, the inverse system 130 is implemented as a specialized computer processor or computer program executed by a general purpose computer. Examples of a specialized processor include, but are not limited to, a discrete logic circuit, a signal processor and an application specific integrated circuit (ASIC). In other embodiments, the inverse system 130 may comprise a filter that filters the product of the chaotic stimulus signal S(t) and the chaotic reference signal C(t). In such embodiments, the filter may comprise a lowpass transfer function and is termed a ‘lowpass’ filter. In various embodiments, the filter may be implemented as one or more of an analog filter and a digital filter, depending on a particular realization and application of the inverse system 130.

In some embodiments, the mixer measurement system 100 illustrated in FIG. 1 further comprises an analysis system 140. The analysis system 140 essentially extracts from the recovered signal ũ(t) the distortions introduced by the MUT 102. The analysis system 140 further quantifies the distortions. In some embodiments, the analysis system 140 is implemented as one or more of a specialized computer processor (e.g., signal processor) or computer program executed by a general purpose computer. A specific implementation of the analysis system 140 depends on a specific distortion or distortions being characterized as well as the method used to extract the distortion(s).

In some embodiments, the analysis system 140 implements an optimization function for a particular metric or metrics of interest. The analysis system 140 further implements an optimization method or technique that employs the optimization function to estimate the metric(s) of interest. The metric of interest is essentially a measure of the distortion introduced by the MUT 102. The optimization function provides a means for assessing a quality of the estimated metric relative to the recovered signal ũ(t).

For example, the metric may represent one or more of various measures of distortion such as, but not limited to, 2^{nd} order harmonic distortion, 3^{rd} order harmonic distortion, total harmonic distortion (THD), third order intercept (TOI), intermodulation distortion (IMD), and adjacent channel power ration (ACPR). Alternatively, the metric of interest may be a parameter a model of the MUT 102 wherein the parameter represents the introduced distortion. Once a value for the parameter is determined by the analysis system 140, one or more other measures of distortion may be computed by the analysis system 140 from the determined parameter.

In an exemplary embodiment, the analysis system 140 implements an optimization function that includes a model of the MUT 102. The model has parameters that represent specific expected distortions. The analysis system 140 further implements a multiple regression algorithm (i.e., optimization method) that estimates parameters of the model (i.e., the metrics of interest). The multiple regression algorithm essentially adjusts the model parameters until an output of the model matches or closely approximates that of the recovered signal ũ(t). Other optimization methods that may be implemented by the analysis system 140 include, but are not limited to, gradient descent, Newton's method, conjugate gradient, simulated annealing, stochastic annealing, and genetic algorithms.

In some embodiments (not illustrated), the chaotic reference source 110 may further comprise a delay element. The delay element may be located in one or both output paths from of the chaotic reference source 110 to a respective one of the MUT 102 and the chaotic excitation source 120, for example. The delay element introduces a time delay in the chaotic reference signal C(t) passing through the delay element. For example, the delay element may be employed to introduce a time delay δt in the chaotic reference signal C(t) that is applied to the LO port of the MUT 102. By introducing the time delay δt, a time-delayed chaotic reference signal C(t-δt) is produced that better corresponds with the chaotic component of the chaotic stimulus signal S(t) as it is applied to the RF port of the MUT 102.

FIG. 3 illustrates a block diagram of a mixer measurement system 100′ according to another embodiment of the present invention. The mixer measurement system 100′ comprises many of the same elements as, and operates in essentially the same manner as, the mixer measurement system 100 described above with reference to FIG. 1. The mixer measurement system 100′ essentially differs from the above-described mixer measurement system 100 the use of a different signal source 120′ and an addition of a mixer 152 in the receiver 150. Furthermore, the MUT 102 acts as an upconverter in the mixer measurement system 100′ such that a first input port of the MUT 102 is an LO input port, a second input port of the MUT 102 is an IF input port, and an output port of the MUT 102 is an RF port.

As illustrated in FIG. 3, the mixer measurement system 100′ comprises the chaotic reference source 110 and in some embodiments, comprises the analysis system 140, as described above with respect to FIG. 1. The mixer measurement system 100′ further comprises an excitation source 120′. The excitation source 120′ is essentially similar to the signal source 122 described above with respect to FIG. 2. Specifically, the excitation source 120′ generates the input signal u(t). As illustrated in FIG. 3, the excitation source 120′ is connected to and applies the input signal u(t) to the second input port (e.g., IF input port) of the MUT 102. The chaotic reference source 110 is connected to and applies the chaotic references signal C(t) to the first input port (e.g., LO input port) of the MUT 102. The MUT 102 generates a response signal R′(t) at the output port (e.g., RF port).

The mixer measurement system 100′ further comprises a receiver 150. The receiver 150 receives the response signal R′(t) and using the inverse system 154, generates the recovered signal ũ(t) as an output signal. In some embodiments, the receiver 150 is a chaotic lock-in amplifier (CLA) 150. The CLA 150 is connected to the output port of the MUT 102 and receives the response signal R′(t) from the MUT 102. The CLA 150 is further connected to the chaotic reference source 110 and receives the chaotic reference signal C(t) from the chaotic reference source 110. An output of the CLA 150 is connected to the analysis system 140, depending on the embodiment. Various implementations of the CLA 150 are described by Tufillaro et al., in co-pending U.S. patent application Ser. No. 11/314,791, filed Dec. 21, 2005, incorporated herein by reference.

As illustrated in FIG. 3, the CLA 150 comprises a mixer 152 and an inverse system 154. The inverse system 154 is essentially similar to the inverse system 130 described above. In some embodiments, the mixer 152 is an analog mixer that multiplies together a pair of input signals to produce a product of signals as an output.

The mixer 152 accepts at a first input port (e.g., LO port) the chaotic reference signal C(t). The mixer 152 further accepts at a second input port (e.g., RF input port) the response signal R′(t) from the MUT 102. The mixer 152 multiplies together the chaotic reference signal C(t) and the response signal R′(t) to produce a downconverted response signal r(t) representing the product of the two signals C(t) times R′(t). The downconverted response signal r(t) is applied to the inverse system 154. The inverse system 154 converts the downconverted response signal r(t) into the recovered signal ũ(t) in a manner analogous to that employed with the mixer measurement system 100.

Consider, for example and not by way of limitation, the mixer measurement system 100 illustrated in FIG. 1, wherein a third order distortion product of the MUT 102 is to be characterized. In the exemplary mixer characterization, a response of the MUT 102 may be modeled by
w(t)=s₁(t)(s₂(t)+εs₂(t)³) (5)
where w(t) is an output signal and s₁(t) and s₂(t) are input signals. A coefficient ε represents or models a relative level of a third order distortion product produced by the MUT 102. For example, in terms of the discussion above, w(t) may be the response signal R(t), s₁(t) may be the chaotic stimulus signal S(t), and s₂(t) may be the chaotic reference signal C(t). In the example, a value for the coefficient ε in equation (5) is determined using the mixer measurement system 100 to characterize the third order distortion product of the MUT 102.

For the example, the chaotic reference source 110 employs a 3-dimensional chaotic system defined in terms of a state vector q and its time derivative q′ and are described by

$$\begin{matrix}[ \begin{matrix}{q}_{1}^{′} \\ {q}_{2}^{′} \\ {q}_{3}^{′}\end{matrix} ] = [ \begin{matrix}{q}_{2} - 0.001 {q}_{1} \\ {q}_{3} \\ {q}_{1} - {q}_{2} - 0.7 {q}_{3} - {q}_{1}^{3} + {( {q}_{1} + d )}^{2} u ( t )\end{matrix} ] \\ where & ( 6 ) \\ q ≡ [ \begin{matrix}{q}_{1} \\ {q}_{2} \\ {q}_{3}\end{matrix} ] and {q}^{′} ≡ [ \begin{matrix}{q}_{1}^{′} \\ {q}_{2}^{′} \\ {q}_{3}^{′}\end{matrix} ] & ( 7 )\end{matrix}$$

where the variable d is an offset and where the input signal u(t) is an arbitrary signal. For example, the input signal u(t) may be given by
u(t)=a+b cos(ωt) (8)
where variables a and b are arbitrary scalar constants and ω is a frequency of the input signal u(t). The exemplary chaotic reference source 110 generates a chaotic reference signal C(t) equal to a first state variable q₁. Note that a time-dependence of the state variables {q₁, q₂, q₃} and their respective derivatives is suppressed herein for clarity of description. Also note that the 3-dimensional chaotic system of equation (6) explicitly employs the input signal u(t) which may be provided to the chaotic reference source 110 by way of a connection (not illustrated) between the signal source 122 of the chaotic excitation source 120 and the chaotic reference source 110 (referring to FIGS. 1 and 2).

The chaotic excitation source 120 in the example generates an excitation signal S(t) that is a product of the input signal u(t) and the chaotic reference signal C(t) described by
S(t)=u(t)q₁ (9)
For purposes of discussion, and not by way of limitation, the exemplary excitation signal S(t) is assumed to be an ideal or undistorted signal. Specifically, as defined by equation (9), the exemplary excitation signal S(t) includes no distortion products from the multiplication in the modulator 124. In practice, an ideal modulator 124 is not readily realizable. However, in many cases, a distortion introduced by the modulator 124 is significantly smaller than that expected from the MUT 102 such that the modulator-introduced distortion may be ignored. For example, the modulator 124 may comprise a “golden” mixer or an instrumentation mixer that is specially designed and carefully tuned to provide a low or very low THD compared to an expected THD of the MUT 102. Alternatively, a more general form of equation (9) may be readily constructed that explicitly accounts for the modulator-introduced distortion without departing from the scope of the present invention.

A response signal R(t) of the MUT 102, in turn, is described by
R(t)=S(t)·g(C(t))=u(t)q₁·(q₁+εq₁³) (10)
where a distortion function g(·) describes a distortion introduced by the MUT 102. For the example, the distortion is assumed to be the third order distortion described above in equation (5). However, essentially any distortion function g(·) may be employed in modeling the response signal R(t) without departing from the scope of the present invention. Moreover, other distortions not described by equation (10) may be included in a model of, or an equation that describes, the response signal R(t) without exceeding the scope of the present invention. For example, such other distortions may include, but are not limited to, a distortion of the excitation signal S(t) introduced by the MUT 102 (e.g., gₐ(S(t)) where gₐ(·) is another arbitrary distortion function) and various intermodulation distortions by the MUT 102 involving both the chaotic reference signal C(t) and the chaotic excitation signal S(t) (e.g., g_{IM}(S(t),C(t)) where g_{IM}(·) is an arbitrary intermodulation distortion function).

Continuing with the example, the inverse system 130 of FIG. 1 may employ a 3-dimensional inverse chaotic system defined in terms of a state vector z and its time derivative z′ and are described by

$$\begin{matrix}[ \begin{matrix}{z}_{1}^{′} \\ {z}_{2}^{′} \\ {z}_{3}^{′}\end{matrix} ] = [ \begin{matrix}{z}_{2} - 0.001 {z}_{1} \\ {z}_{3} \\ {z}_{1} - {z}_{2} - 0.7 {z}_{3} - {z}_{1}^{3} + ( y - c \cdot z )\end{matrix} ] \\ where & ( 11 ) \\ z ≡ [ \begin{matrix}{z}_{1} \\ {z}_{2} \\ {z}_{3}\end{matrix} ] and {z}^{′} ≡ [ \begin{matrix}{z}_{1}^{′} \\ {z}_{2}^{′} \\ {z}_{3}^{′}\end{matrix} ] & ( 12 )\end{matrix}$$

and where a response variable y is given by
y=c·q+R(t). (13)
The recovered signal ũ(t) is given by

$$\tilde{u} ( t ) = \frac{( y - c \cdot z )}{{z}_{1}^{2}} . \qquad ( 14 )$$

A vector c in equations (11), (13) and (14) is a selection vector. The selection vector c is a row vector that essentially ‘selects’ from each of the state vectors q and z one of the respective state variables. For example, c=[1,0,0] is used in equation (13) to select a first state variable q₁ from the state vector q, and similarly in equations (11) and (14) to select a first state variable z₁ from the state vector z (i.e., [1,0,0]·q=q₁ and [1,0,0]z·=z₁).

When employing a non-zero selection vector c, a connection between the chaotic reference source 110 and the inverse system 130 may be used to supply to the inverse system 130 with the appropriate the state variable {q₁, q₂, q₃} for processing according to equation (13). When no connection between the chaotic reference source 110 and the inverse system 130, 154 is illustrated, the selection vector c is identically zero (i.e., c=[0, 0, 0]).

In order to determine the coefficient ε in the example, the recovered signal ũ(t) is processed by the analysis system 140. In some embodiments, a multiple linear regression method is employed to estimate the coefficient ε such that a difference between the input signal u(t) and the recovered signal ũ(t) is minimized. Multiple linear regression methods are familiar to the skilled artisan. While a multiple regression is employed in the example herein, any other method of estimating a value for the coefficient ε such that the difference is minimized may be used instead of or in addition to the multiple regression.

When employing the multiple linear regression, a comparison between the recovered signal ũ(t) and the input signal u(t) is performed using a parametric dependence defined by
ũ(t)=h(u(t),q₁,ε) (15)
wherein h(·) is a bivariate polynomial in terms of u(t) and q₁. Multiple linear regression is used to find coefficients of the polynomial h(·). By expanding the term ‘y−c·z’ in equation (11), a formula may be obtained that provides an estimate of the coefficient ε denoted by ε*. Specifically, by examining the coefficient of an u¹q⁰₁ term of the polynomial h(·), denoted as a term r herein, a relationship between the term r and the estimate ε* can be determined. The determined relationship is given by

$${ɛ}^{*} = \frac{r}{2 {d}^{4}} \qquad ( 16 )$$

In particular, for 1e⁻⁶<ε<1e⁻¹, there is a linear relationship between the actual nonlinearity represented by the coefficient ε and the estimate ε*. Thus, the estimate ε* provides a good characterization of the nonlinearity of the exemplary MUT 102 modeled in the example. The above discussion and ranges are presented for discussion purposes only and are not intended to limit the scope of the present invention.

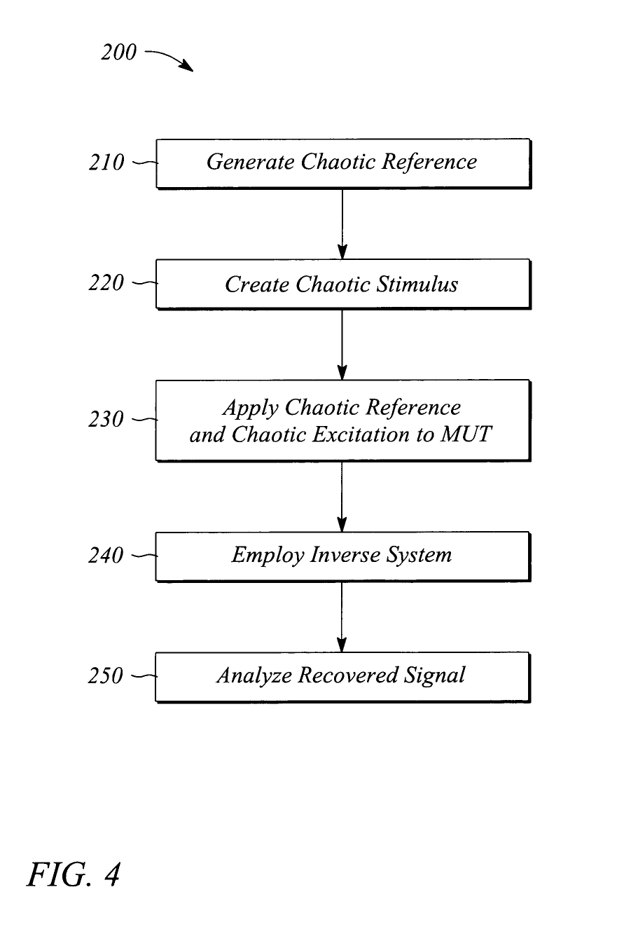

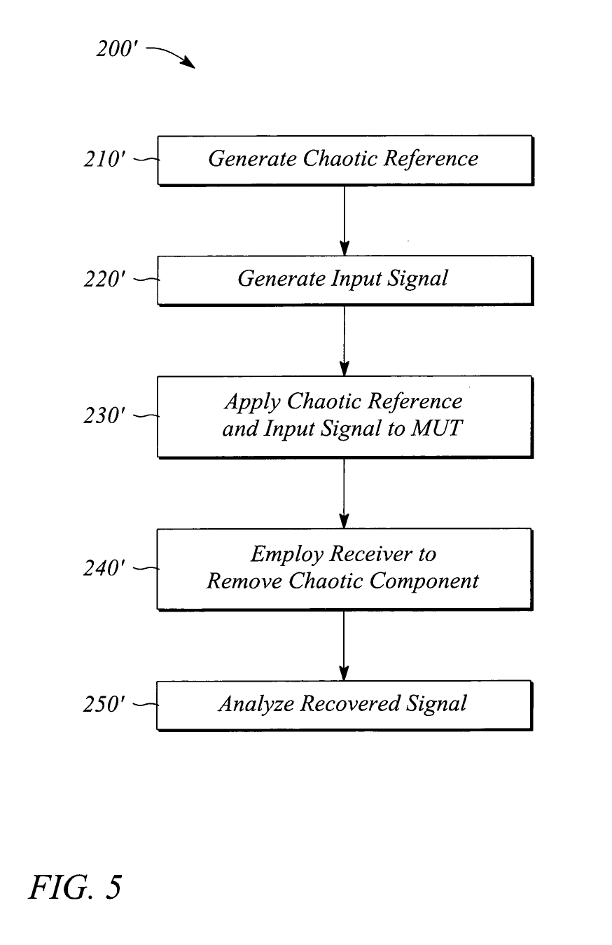

FIGS. 4 and 5 illustrate flow charts of methods of characterizing a mixer using chaotic stimulation according to embodiments of the present invention. The methods include applying a chaotic stimulus to a mixer under test to generate a response signal therefrom, and employing an inverse system to remove a chaotic component from the response signal such that a recovered signal is obtained. The recovered signal has an included distortion that is characteristic of the mixer under test. FIG. 4 illustrates a flow chart of a method 200 of characterizing a mixer using chaotic stimulation according to an embodiment of the present invention. In various embodiments, the method 200 of characterizing a mixer comprises generating 210 a chaotic reference signal C(t). The chaotic reference signal C(t) is essentially any signal having or exhibiting chaotic oscillation, as described above. For example, the chaotic reference signal C(t) may be generated 210 by a chaotic system such as, but not limited to, a Lorenz system.

The method 200 of characterizing a mixer further comprises generating 220 a chaotic stimulus signal S(t). When generated 220, the chaotic stimulus signal S(t) comprises at least one signal component that is proportional to the chaotic reference signal C(t). The chaotic stimulus signal S(t) is a stimulus signal of a form that is compatible with stimulating a response from the mixer being characterized or under test (MUT). In some embodiments, the chaotic stimulus signal S(t) is created by modulating an input signal u(t) with the chaotic referenced signal C(t). For example, generating a chaotic stimulus signal S(t) 220 may comprise multiplying together the chaotic reference signal C(t) and the input signal u(t) to produce a product of the two signals.

The method 200 of characterizing a mixer further comprises applying 230 the chaotic reference signal C(t) and the chaotic stimulation signal S(t) to the MUT. In some embodiments, the chaotic reference signal C(t) is applied to a first input of the MUT (e.g., an LO input). In some embodiments, the chaotic stimulation signal S(t) is applied to a second input of the MUT (e.g., an RF input). Applying 230 the signals causes the MUT to produce a chaotic response signal R(t).

In general, the chaotic response signal R(t) includes a distortion introduced by the MUT. The introduced distortion is that which is characterized by the method 200. For example, the distortion may include a third order distortion. However, essentially any distortion or combination of distortions may be characterized by the method 200 and thus, are within the scope of the various embodiments of the present invention.

The method 200 of characterizing a mixer further comprises employing 240 an inverse system to remove a chaotic component from the chaotic response signal R(t) generated by the MUT. The inverse system essentially implements a mathematical inverse of, and is synchronized to, a chaotic dynamical system used to generate the chaotic reference signal C(t). As such, employing 240 the inverse system essentially removes the chaotic signal component(s) of the chaotic response signal R(t) to generate a recovered signal ũ(t). The recovered signal ũ(t) is essentially the input signal u(t) plus the distortions introduced by the MUT.

In some embodiments, the method 200 of characterizing a mixer further comprises analyzing 250 the recovered signal ũ(t) to extract an estimate of the distortions. In some embodiments, analyzing 250 comprises comparing the input signal u(t) to the recovered signal ũ(t). For example, a model of the distortions may be constructed wherein the model incorporates coefficients that represent distortion terms of interest. A difference between the recovered signal ũ(t) and the input signal u(t) may be minimized using the model to assign values to the model coefficients. The coefficient values then represent an estimate of the distortions. A multiple linear regression using a bivariate polynomial is an example of an optimization or minimization method that may be employed, as described above by way of example.

FIG. 5 illustrates a flow chart of a method 200′ of characterizing a mixer using chaotic stimulation according to another embodiment of the present invention. The method 200′ of characterizing a mixer is similar to the method 200 described hereinabove except for differences in the stimulation of the MUT and the removal of the chaotic component. The method 200′ of characterizing a mixer essentially differs from the above-described method 200 of characterizing a mixer in the signals that are applied to the MUT 102 and how the chaotic component is removed, because the MUT 102 acts as an upconverter in the method 200′ and acts as a downconverter in method 200.

In various embodiments, the method 200′ of characterizing a mixer comprises generating 210′ a chaotic reference signal C(t). Generating 210′ a chaotic reference signal C(t) is essentially similar to generating 210 a chaotic reference signal C(t) that is described above with respect to the method 200.

The method 200′ of characterizing a mixer further comprises generating 220′ an arbitrary input signal u(t). The arbitrary input signal u(t) may be essentially any signal compatible with, or in a frequency range of, an input port of the MUT. For example, the input signal u(t) may be a sinusoidal signal with a center frequency at or near a center of a frequency band of interest for the characterization. In some embodiments, the arbitrary input signal u(t) is essentially similar to the input signal u(t) described above with respect to the mixer measurements system 100, 100′ and the method 200 of characterizing a mixer.

The method 200′ of characterizing a mixer further comprises applying 230′ to the MUT the chaotic reference signal C(t) and the arbitrary input signal u(t). In some embodiments, the chaotic reference signal C(t) is applied to a first input of the MUT (e.g., an LO input). In some embodiments, the arbitrary input signal u(t) is applied to a second input of the MUT (e.g., an RF input). Applying 230′ the signals causes the MUT to produce a response signal R′(t).

As described above for the method 200, the response signal R′(t) includes a distortion introduced by the MUT. The introduced distortion in the response signal R′(t) is characterized by the method 200′ not unlike the introduced distortion in the response signal R(t) being characterized by the method 200. For example, the distortion may include a third order distortion. However, essentially any distortion or combination of distortions may be characterized by and thus, are within the scope of the various embodiments of the present invention.

The method 200′ of characterizing a mixer further comprises employing 240′ a receiver to remove a chaotic component from the response signal R′(t) generated by the MUT to produce a recovered signal ũ(t). In some embodiments, employing 240′ a receiver comprises multiplying the response signal R′(t) with the chaotic reference signal C(t) to produce a downconverted response signal r(t). Employing 240′ further comprises applying the downconverted response signal r(t) to an inverse system. The inverse system essentially implements a mathematical inverse of and is synchronized to a chaotic dynamical system used to generate the chaotic reference C(t). As such, the inverse system essentially removes the chaotic signal component(s) of the chaotic downconverted response signal r(t) to generate the recovered signal ũ(t). The recovered signal ũ(t) is essentially the input signal u(t) plus the distortions introduced by the MUT.

The method 200′ of characterizing a mixer further comprises analyzing 250′ the recovered signal ũ(t) to extract an estimate of the distortions. In some embodiments, analyzing 250′ the recovered signal ũ(t) comprises comparing the input signal u(t) to the recovered signal ũ(t). In some embodiments, analyzing 250′ is essentially similar to analyzing 250 described above with respect to the method 200.

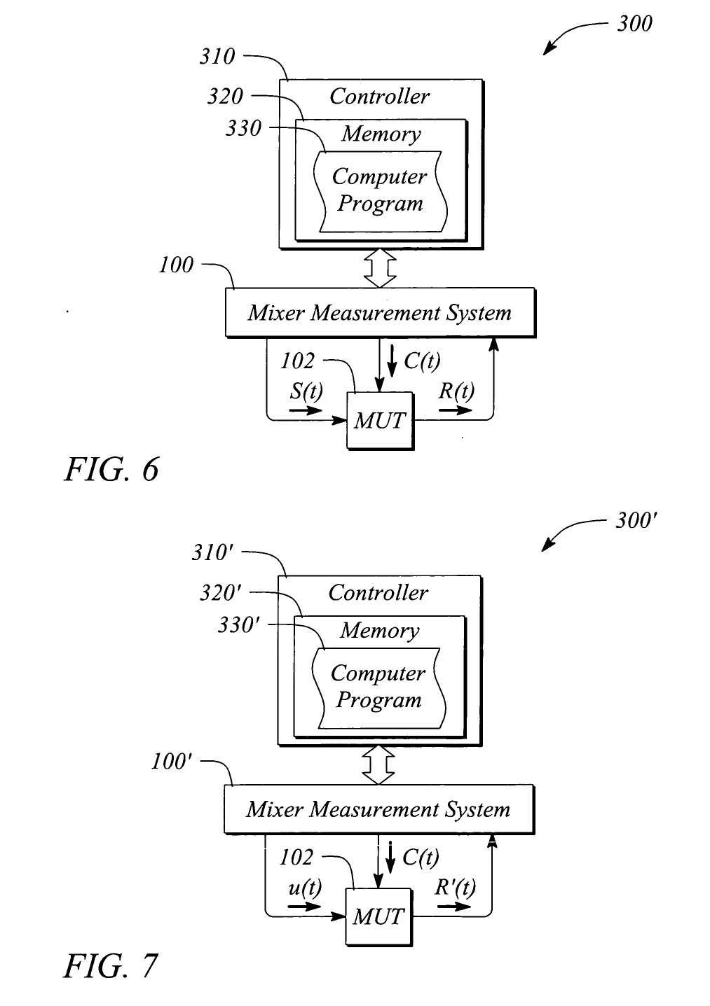

FIG. 6 illustrates a mixer measurement system 300 according to another embodiment of the present invention. In this embodiment, the mixer measurement system 300 comprises the mixer measurement system 100 described above. The mixer measurement system 300 further comprises a controller 310 that controls an operation of elements of the mixer measurement system 100. In various embodiments, the controller 310 is implemented as one or more of a general purpose computer, a special purpose processor or microprocessor, a portion of an application specific integrated circuit (ASIC), and a discrete logic circuit. The measurement system 300 further comprises a memory 320 and a computer program 330 stored in the memory 320. In some embodiments, the controller 310 may comprise the memory 320, as illustrated in FIG. 6. In other embodiments, the memory 320 may be separate from the controller 310 (not illustrated).

Instructions of the computer program 330, when executed by controller 310, implement a method of characterizing a mixer. For example, the instructions of the computer program 330 implement stimulating the mixer with chaotic signals at different input ports of the mixer to obtain a chaotic response signal from the mixer. The chaotic response signal comprises distortions of the mixer to be characterized. The instructions of the computer program 330 further implement removing the chaotic component of the response signal to produce a recovered signal that may be analyzed for the distortions. In some embodiments, the instructions of the computer program 330 implement one or more embodiments of the method 200 described above. In some embodiments, all or a portion of the inverse system 130 of the mixer measurement system 100 may be implemented by a combination of the controller 310 and executable instructions of the computer program 330. In some embodiments, all or a portion of the analysis system 140 of the mixer measurement system 100 is implemented by a combination of the controller 310 and executable instructions of the computer program 330.

FIG. 7 illustrates a mixer measurement system 300′ according to another embodiment of the present invention. In this embodiment, the mixer measurement system 300′ comprises the mixer measurement system 100′ described above. The mixer measurement system 300′ further comprises a controller 310′ that controls an operation of elements of the mixer measurement system 100′. In various embodiments, the controller 310′ is implemented as one or more of a general purpose computer, a special purpose processor or microprocessor, a portion of an application specific integrated circuit (ASIC), and a discrete logic circuit. The measurement system 300′ further comprises a memory 320′ and a computer program 330′ stored in the memory. In some embodiments, the controller 310′ may comprise the memory 320′ as illustrated in FIG. 7. In other embodiments, the memory 320′ may be separate from the controller 310′ (not illustrated).

Instructions of the computer program 330′, when executed by controller 310′, implement a method of characterizing a mixer. For example, the instructions of the computer program 330′ implement stimulating the mixer with a chaotic reference signal and an input signal at different input ports of the mixer to obtain a chaotic response signal from the mixer. The chaotic response signal comprises distortions of the mixer to be characterized. The instructions of the computer program 330′ further implement removing the chaotic component of the response signal to produce a recovered signal that may be analyzed for the distortions. In some embodiments, the instructions of the computer program 330′ implement one or more embodiments of the method 200′ described above. In some embodiments, all or a portion of the input signal source 120′ of the mixer measurement system 100′ is implemented by a combination of the controller 310′ and executable instructions of the computer program 330′. In some embodiments, all or a portion of the receiver 150 of the mixer measurement system 100′ is implemented by a combination of the controller 310′ and executable instructions of the computer program 330′. In some embodiments, all or a portion of the analysis system 140 of the mixer measurement system 100′ is implemented by a combination of the controller 310′ and executable instructions of the computer program 330′.

Thus, there have been described embodiments of a mixer measurement system and respective methods of characterizing a mixer that both employ chaotic stimulation. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

1. A mixer measurement system comprising:
a chaotic reference source having an output that produces a chaotic reference signal on a first input of a mixer under test;
an excitation source having an output that produces a stimulus signal on a second input of the mixer under test, the mixer under test generating a response signal that includes a distortion introduced by the mixer under test;
an inverse system that removes a chaotic component from the response signal to measure a recovered signal that includes the distortion; and
an analysis system connected to an output of the inverse system that analyzes the included distortion in the recovered signal.

2. The mixer measurement system of claim 1, wherein the output of the chaotic reference source is further connected to an input of the excitation source.

3. The mixer measurement system of claim 1, wherein the excitation source is a chaotic excitation source that comprises a signal source and a modulator, an output of the signal source being connected to a first input of the modulator, the modulator having a second input that is connected to an input of the chaotic excitation source, the output of the chaotic reference source being connected to the second input of the modulator by way of the chaotic excitation source input, an output of the modulator being connected to the output of the chaotic excitation source.

4. The mixer measurement system of claim 3, wherein the modulator produces a chaotic signal as the stimulus signal at the output of the chaotic excitation source, the chaotic stimulus signal being a modulation of a signal from the signal source that is proportional to the chaotic reference signal.

5. The mixer measurement system of claim 1, wherein the output of the chaotic reference source is further connected to an input of the inverse system.

6. The mixer measurement system of claim 1, further comprising a receiver having a first input connected to an output of the mixer under test, the receiver comprising a mixer and the inverse system, the mixer having a first input connected to the first input of the receiver, a second input connected to a second input of the receiver, and an output connected to an input of the inverse system, the inverse system having an output connected to an output of the receiver,
wherein the response signal and the chaotic reference signal are applied to the inputs of the receiver such that the signals are mixed by the mixer, a mixed response signal from the mixer being applied to the inverse system, and
wherein the excitation source applies a nonchaotic signal as the produced stimulus signal to the second input of the mixer under test.

7. (canceled)

8. The mixer measurement system of claim 1, wherein the analysis system estimates a coefficient representing a relative level of the included distortion.

9. The mixer measurement system of claim 1, further comprising:
a controller that controls the chaotic reference source, the excitation source and the inverse system;
a memory that is accessible by the controller; and
a computer program stored in the memory, the computer program having instructions that are executed by the controller, wherein the executed instructions implement measuring the recovered signal from the mixer under test.

10. The mixer measurement system of claim 9,
wherein the controller further controls the analysis system, the instructions of the computer program further implementing analyzing the included distortion in the recovered signal, such that a coefficient representing a relative level of the included distortion is estimated.

11. A mixer measurement system comprising:
a controller;
a memory that is accessible by the controller; and
a computer program stored in the memory, the computer program having instructions that are executed by the controller, wherein the executed instructions implement applying a chaotic reference signal and a stimulus signal on inputs of a mixer under test, employing an inverse system to remove a chaotic component in a response signal from an output of the mixer under test such that a recovered signal is measured, the recovered signal including a distortion that is characteristic of the mixer under test, and analyzing the recovered signal for an estimate of the included distortion.

12. The mixer measurement system of claim 11, wherein the stimulus signal is a chaotic stimulus signal that is proportional to the chaotic reference signal.

13. The mixer measurement system of claim 11, wherein the stimulus signal is a nonchaotic stimulus signal, the chaotic reference signal being further applied to the response signal before the instructions that implement employing the inverse system are executed.

14. (canceled)

15. A mixer measurement system comprising:
a chaotic reference source that produces a chaotic reference signal;
a chaotic excitation source that produces a chaotic stimulus signal from the chaotic reference signal; and
an inverse system,
wherein the chaotic reference signal and the chaotic stimulus signal are applied to respective inputs of a mixer under test to produce a response signal that includes a distortion introduced by the mixer and wherein the inverse system removes from the response signal a chaotic component to produce a recovered signal that includes the distortion.

16. The mixer measurement system of claim 15, wherein the chaotic excitation source comprises a signal source and a modulator, the modulator receiving the chaotic reference signal and producing a modulation of a signal from the signal source that is proportional to the chaotic reference signal.

17. A method of characterizing a mixer, the method comprising:
applying a stimulus signal and a chaotic reference signal to inputs of a mixer under test to produce a response signal from an output of the mixer under test;
employing an inverse system on the response signal to remove a chaotic component from the response signal such that a recovered signal having an included distortion that is characteristic of the mixer under test is produced;
analyzing the included distortion in the recovered signal; and
providing a result of analyzing as an output product that characterizes the mixer under test.

18. The method of characterizing of claim 17, further comprising:
generating the chaotic reference signal; and
generating the stimulus signal having at least one signal component that is proportional to the chaotic reference signal, both of the chaotic reference signal and the stimulus signal being generated before applying the respective signals to the mixer under test.

19. The method of characterizing of claim 17, further comprising:
generating the chaotic reference signal;
generating a nonchaotic signal as the stimulus signal, both of the chaotic reference signal and the nonchaotic stimulus signal being generated before applying the respective signals to the mixer under test, and further comprising:
applying the chaotic reference signal to the response signal before employing the inverse system.

20. (canceled)

21. The method of characterizing of claim 17, wherein employing an inverse system comprises employing a chaotic lock-in amplifier to remove the chaotic component.
